(19) United States
(12) Patent Application Publication
(10) Pub. No.: US 2026/0154623 A1
(43) Pub. Date: Jun. 4, 2026

(54) METHOD AND APPARATUS FOR TRAINING MULTIMODAL LARGE MODEL, AND METHOD AND APPARATUS FOR IMAGE QUESTION ANSWERING

(71) Applicant: BEIJING BAIDU NETCOM SCIENCE TECHNOLOGY CO., LTD., Beijing (CN)

(72) Inventors: Xintong YU, Beijing (CN); Songhe DENG, Beijing (CN); Weixin LIU, Beijing (CN); Shikun FENG, Beijing (CN)

(73) Assignee: BEIJING BAIDU NETCOM SCIENCE TECHNOLOGY CO., LTD., Beijing (CN)

(21) Appl. No.: 19/464,431

(22) Filed: Jan. 29, 2026

(30) Foreign Application Priority Data
Jun. 16, 2025 (CN) 202510804373.2

(51) Int. Cl. G06N 20/00; G06V 10/22; G06V 30/19

(52) U.S. Cl. CPC G06N 20/00; G06V 10/22; G06V 30/1912

(57) ABSTRACT

Method and apparatus for training multimodal large model and method and apparatus for image question answering are disclosed, which relates to artificial intelligence technologies such as large models, deep learning, natural language processing, and computer vision. The method for training multimodal large model includes: obtaining an initial sample image, a sample object in the initial sample image, and a location information of the sample object; obtaining a target sample image including a sample visual marker based on the initial sample image and a target image region corresponding to the initial sample image; obtaining a sample question corresponding to the target sample image based on the sample visual marker, and obtaining a sample answer corresponding to the sample question; training an initial multimodal large model based on a target training sample constituted by the target sample image, the sample question and the sample answer to obtain a target multimodal large model. The method for image question answering includes: obtaining a target image including a target visual marker and a target question; inputting the target image and the target question into the target multimodal large model to obtain a target answer. The present disclosure enables the target multimodal large model to effectively understand the target visual marker in the target image, thereby improving the accuracy of the target answer.

The present application claims the priority of Chinese Patent Application No. 202510804373.2, filed on Jun. 16, 2025, with the title of “Method and Apparatus for Training Multimodal Large Model, and Method and Apparatus for Image Question Answering”. The disclosure of the above application is incorporated herein by reference in its entirety.

### FIELD OF THE DISCLOSURE

The present disclosure relates to the field of computer technology, particularly to artificial intelligence technologies such as large models, deep learning, natural language processing, and computer vision. The present disclosure provides a method and an apparatus for training multimodal large model, and a method and an apparatus for image question answering.

### BACKGROUND OF THE DISCLOSURE

When using multimodal large models for question answering about image content, users frequently ask questions about specific local regions of images. In conventional technologies, in order to enable multimodal large models to understand local regions of images, users typically either manually crop and upload images, or use natural language to describe the regions of interest. However, conventional methods have problems such as the multimodal large model's inability to understand the overall information of the image, and misunderstandings caused by natural language descriptions. Therefore, how to enable multimodal large models to understand and answer questions about local regions of images has become an urgent technical problem to be solved.

### SUMMARY OF THE DISCLOSURE

According to a first aspect of the present disclosure, a method for training multimodal large model is provided, including: obtaining an initial sample image, a sample object in the initial sample image, and a location information of the sample object; obtaining a target sample image including a sample visual marker based on the initial sample image and a target image region corresponding to the initial sample image; obtaining a sample question corresponding to the target sample image based on the sample visual marker, and obtaining a sample answer corresponding to the sample question; training an initial multimodal large model based on a target training sample constituted by the target sample image, the sample question and the sample answer to obtain a target multimodal large model.

According to a second aspect of the present disclosure, a method for image question answering is provided, including: obtaining a target image and a target question, wherein the target image includes a target visual marker; inputting the target image and the target question into a target multimodal large model, and obtaining a target answer corresponding to the target question based on an output result of the target multimodal large model.

According to a third aspect of the present disclosure, there is provided an electronic device, including: at least one processor; and a memory communicatively connected with the at least one processor; wherein the memory stores instructions executable by the at least one processor, and the instructions are executed by the at least one processor to enable the at least one processor to perform a method for training multimodal large model, wherein the method for training multimodal large model includes: obtaining an initial sample image, a sample object in the initial sample image, and a location information of the sample object; obtaining a target sample image including a sample visual marker based on the initial sample image and a target image region corresponding to the initial sample image; obtaining a sample question corresponding to the target sample image based on the sample visual marker, and obtaining a sample answer corresponding to the sample question; training an initial multimodal large model based on a target training sample constituted by the target sample image, the sample question and the sample answer to obtain a target multimodal large model.

According to a fourth aspect of the present disclosure, there is provided a non-transitory computer readable storage medium with computer instructions stored thereon, wherein the computer instructions are used for causing a method for training multimodal large model, wherein the method for training multimodal large model includes: obtaining an initial sample image, a sample object in the initial sample image, and a location information of the sample object; obtaining a target sample image including a sample visual marker based on the initial sample image and a target image region corresponding to the initial sample image; obtaining a sample question corresponding to the target sample image based on the sample visual marker, and obtaining a sample answer corresponding to the sample question; training an initial multimodal large model based on a target training sample constituted by the target sample image, the sample question and the sample answer to obtain a target multimodal large model.

It should be understood that the content described in this section is not intended to identify key or essential features of the embodiments of the present disclosure, nor is it intended to limit the scope of the present disclosure. Other features of the present disclosure will become readily understood through the following specification.

### BRIEF DESCRIPTION OF DRAWINGS

The drawings are used to better understand the present solution and do not constitute a limitation on the present disclosure. In the drawings:

FIG. 1 is a schematic diagram according to a first embodiment of the present disclosure;

FIG. 2 is a schematic diagram according to a second embodiment of the present disclosure;

FIG. 3 is a schematic diagram according to a third embodiment of the present disclosure;

FIG. 4 is a schematic diagram according to a fourth embodiment of the present disclosure;

FIG. 5 is a schematic diagram according to a fifth embodiment of the present disclosure;

FIG. 6 is a schematic diagram according to a sixth embodiment of the present disclosure;

FIG. 7 is a block diagram of an electronic device for implementing the method for training multimodal large model or the method for image question answering according to embodiments of the present disclosure.

### DETAILED DESCRIPTION OF PREFERRED EMBODIMENTS

The following description of exemplary embodiments of the present application is made with reference to the accompanying drawings, which includes various details of the embodiments of the present application to aid understanding, and should be considered merely exemplary. Therefore, those skilled in the art should recognize that various changes and modifications can be made to the embodiments described herein without departing from the scope and spirit of the present application. Similarly, for clarity and conciseness, descriptions of known functions and structures are omitted in the following description.

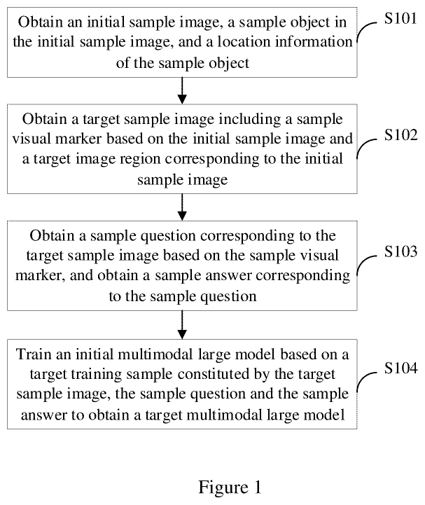

FIG. 1 is a schematic diagram according to a first embodiment of the present disclosure. As shown in FIG. 1, a method for training multimodal large model specifically includes the following steps of:
S101: Obtaining an initial sample image, a sample object in the initial sample image, and a location information of the sample object;
S102: Obtaining a target sample image including a sample visual marker based on the initial sample image and a target image region corresponding to the initial sample image;
S103: Obtaining a sample question corresponding to the target sample image based on the sample visual marker, and obtaining a sample answer corresponding to the sample question;
S104: Training an initial multimodal large model based on a target training sample constituted by the target sample image, the sample question and the sample answer to obtain a target multimodal large model.

With the method for training multimodal large model of the present embodiment, on one hand, it can achieve a purpose of automatically constructing a target training sample based on the sample object and location information of the sample object in the initial sample image, which can reduce a cost of obtaining the target training sample and improve an efficiency of obtaining the target training sample. On the other hand, by training the initial multimodal large model using the constructed target training sample, the obtained target multimodal large model can effectively understand a target visual marker in a target image, thereby improving the accuracy of a target answer obtained by the target multimodal large model based on the target image containing the target visual marker and a target question.

In the present embodiment, a multimodal large model refers to an artificial intelligence model capable of simultaneously processing and understanding a plurality of types (i.e., a plurality of modalities) of data (such as text, images, audio, video, etc.); by integrating and understanding data from different modalities, the multimodal large model can perform more complex and diverse tasks.

In the present embodiment, the sample object in the initial sample image can be a sample text included in the initial sample image, and the location information of the sample object is location information of the sample text in the initial sample image; Additionally, the sample object in the present embodiment can also be a sample entity such as an object or a person included in the initial sample image, and location information of the sample entity is location information of the aforementioned entity in the initial sample image.

An initial sample image obtained in the step S101 of the present embodiment can be an image containing only a sample text (where a text in the sample image is the sample text), such as various types of document images including a table document, a text document, a chart document, etc.; The initial sample image can also be an image that contains the sample text, meaning that besides the sample text, the initial sample image can also include another sample entity such as an object and a person.

After obtaining the initial sample image in the step S101, the present embodiment can perform Optical Character Recognition (OCR) on the initial sample image, and then obtain at least one sample text in the initial sample image and the location information of the at least one sample text in the initial sample image based on OCR recognition results.

After obtaining the initial sample image in the step S101, the present embodiment can also input the initial sample image into a first candidate multimodal large model, thereby obtaining at least one sample text in the initial sample image and the location information of the at least one sample text in the initial sample image based on an output result of the first candidate multimodal large model; The first candidate multimodal large model in the present embodiment can be an initial multimodal large model or another type of multimodal large model.

It should be understood that when executing the step S101, the present embodiment can also input an obtained first prompt text together with the initial sample image into a candidate multimodal large model; The first prompt text in the present embodiment is used to instruct the first candidate multimodal large model to obtain sample text and corresponding location information of the sample text from the input initial sample image.

If the sample object in the present embodiment is a sample entity in the initial sample image, when executing the step S101, the present embodiment can obtain the sample entity and location information of the sample entity in the initial sample image through entity detection on the initial sample image.

After obtaining the initial sample image, the sample object in the initial sample image, and the location information in the step S101, the present embodiment executes the step S102 to obtain a target sample image including a sample visual marker based on the initial sample image and a target image region corresponding to the initial sample image; In the present embodiment the sample visual marker in the present embodiment is located in the target image region of the target sample image, which is used to mark a corresponding sample object (for example, at least one sample text) in the target sample image.

It should be understood that the target sample image obtained in the step S102 of the present embodiment, compared with the initial sample image, has only one difference: the target sample image includes a sample visual marker for marking a sample object located within the target image region, while image dimensions and image content are otherwise identical between the two.

If the sample object is sample text, then the sample visual marker in the present embodiment is located in the target image region of the target sample image, which is used to mark the sample text within the target image region.

In the present embodiment, different target sample images can be obtained based on different initial sample images, and in different target sample images, sample visual markers can have different marking styles and/or different marking colors.

When executing the step S102 to obtain a target sample image including a sample visual marker based on the initial sample image and the target image region corresponding to the initial sample image, the present embodiment can implement as follows: determining the target image region corresponding to the initial sample image; inputting the target image region and the initial sample image into a second candidate multimodal large model; obtaining the target sample image including the sample visual marker based on an output result of the second candidate multimodal large model, where the sample visual marker is used to mark a sample object located within the target image region in the target sample image.

If the sample object is a sample text, the target image region determined in the step S102 of the present embodiment can correspond to part of a text line, an entire text line, or a plurality of consecutive text lines in the initial sample image; If the sample object is a sample entity, the target image region determined in the step S102 of the present embodiment can include one or a plurality of sample entities.

In the present embodiment, the second candidate multimodal large model can be the initial multimodal large model or another type of multimodal large model; The second candidate multimodal large model can be the same as or different from the first candidate multimodal large model.

In other words, the present embodiment uses the second candidate multimodal large model to generate a sample visual marker in the target image region of the initial sample image, thereby obtaining a target sample image including the sample visual marker. Since the second candidate multimodal large model can generate a sample visual marker with a different marking style and/or a different marking color in the initial sample image, a diversity of sample visual markers included in different target sample images is enhanced, thereby strengthening an ability of the target multimodal large model to recognize different sample visual markers after training based on different target sample images.

When the sample object is a sample text, the present embodiment can determine the target image region corresponding to the initial sample image in the step S102 using the following method: selecting at least one target text from the sample text included in the initial sample image, where the present embodiment can use random selection to select the at least one target text from a plurality of sample texts, but needs to ensure that a plurality of randomly selected target texts are consecutive; determining the target image region based on the location information of the selected at least one target text.

In other words, the present embodiment determines the target image region corresponding to the initial sample image based on the location information of the target text selected from the initial sample image, achieving a purpose of automatically determining the target image region, thereby improving the efficiency of obtaining a target training sample.

Additionally, when the sample object is a sample text, the present embodiment can also determine the target image region corresponding to the initial sample image based on the text location information input from an input end when executing the step S102; For example, if the input end inputs “the second line text”, the present embodiment determines an image region corresponding to the “the second line text” in the initial sample image as the target image region.

It should be understood that when the sample object is a sample entity, the present embodiment can determine the target image region corresponding to the initial sample image based on the location information corresponding to the sample entity selected from the input end when executing the S102.

When executing the S102, the present embodiment can also input an obtained second prompt text together with the target image region and the initial sample image into the second candidate multimodal large model; The second prompt text in the present embodiment is used to instruct the second candidate multimodal large model to generate a sample visual marker in the target image region of the initial sample image.

When inputting the initial sample image and the corresponding target image region into the second candidate multimodal large model in the step S102, the present embodiment can also include the following content: obtaining a preset marking style, when the sample object is sample text, the preset marking style in the present embodiment can be a box marking, a highlight marking, an underline marking, a bold font marking, etc.; inputting the obtained preset marking style, the target image region and the initial sample image into the second candidate multimodal large model.

In other words, the present embodiment enables the second candidate multimodal large model to generate a sample visual marker corresponding to a preset marking style in the initial sample image by inputting the preset marking style into the second candidate multimodal large model, thereby enhancing an ability of the target multimodal large model to recognize a visual marker of a specific style after training; It should be noted that the present embodiment does not restrict a marking color of the generated sample visual marker.

After obtaining the target sample image including a sample visual marker in the step S102, the present embodiment executes the step S103 to obtain a sample question corresponding to the target sample image based on the sample visual marker, and obtain a sample answer corresponding to the sample question.

When executing the step S103, the present embodiment first obtains the sample question based on the sample visual marker, and then further obtains the corresponding sample answer based on the sample question.

When obtaining the sample question based on the sample visual marker in the step S103, the present embodiment can directly obtain the sample question based on a marking style and a marking color of the sample visual marker; wherein the present embodiment can input the marking style and the marking color into a Large Language Model (LLM) and obtain the sample question based on an output result of the large language model.

For example, if the sample visual marker in the target sample image is “yellow highlighted”, then the sample question obtained in the step S103 can be “what is the yellow highlighted text in the image”; If the sample visual marker is “purple box”, then the sample question obtained in the step S103 can be “what is the text inside the purple box in the image”; If the sample visual marker is “red circle”, then the sample question obtained in the step S103 can be “what is the entity inside the red circle in the image”.

When the sample object is a sample text, after obtaining the sample question based on the marking style and the marking color of the sample visual marker in the step S103, the present embodiment can directly obtain at least one sample text (i.e., at least one target text) marked by the sample visual marker in the target sample image as the sample answer corresponding to the sample question.

When the sample object is a sample entity, after obtaining the sample question based on the marking style and the marking color of the sample visual marker in the step S103, the present embodiment can obtain entity information of at least one sample entity marked by the sample visual marker in the target sample image as the sample answer corresponding to the sample question.

After obtaining the sample question and the corresponding sample answer in the step S103, the present embodiment executes the step S104 to train an initial multimodal large model based on a target training sample constituted by the target sample image, the sample question and the sample answer to obtain a target multimodal large model; In the present embodiment, the target multimodal large model obtained through training in the present embodiment is used to obtain a target answer corresponding to a target question based on a target image including a target visual marker (the target visual marker is used to mark an entity or a text in the target image) and the target question.

In other words, the target multimodal large model trained using the target training sample in the present embodiment can recognize a target visual marker included in the target image, and then combine an entity or a text corresponding to the target visual marker in the target image to answer a target question raised by a user, effectively improving an interaction efficiency between the user and the multimodal large model as well as an accuracy of the obtained target answer.

When executing the step S104 to train the initial multimodal large model based on the target training sample constituted by the target sample image, the sample question and the sample answer to obtain the target multimodal large model, the present embodiment can implement as follows: inputting the target sample image and the sample question into the initial multimodal large model to obtain a predicted answer output by the initial multimodal large model; obtaining a target loss function value based on the predicted answer and the sample answer; adjusting parameters of the initial multimodal large model based on the target loss function value to obtain the target multimodal large model.

In other words, the present embodiment determines the target loss function value by combining the predicted answer and the sample answer, and then adjusts the parameters of the initial multimodal large model based on the target loss function value, which can improve the training speed and the training accuracy of the model.

Additionally, when the sample object is sample text, when executing the step S104 to train the initial multimodal large model based on the target training sample constituted by the target sample image, the sample question and the sample answer to obtain the target multimodal large model, the present embodiment can also include the following content: obtaining an initial training sample based on the initial sample image and a sample text in the initial sample image; training the initial multimodal large model using the target training sample and the obtained initial training sample to obtain the target multimodal large model; wherein a quantity of the target training sample used in the present embodiment is equal to a quantity of the initial training sample.

In other words, the present embodiment uses the target training sample and the initial training sample to train the initial multimodal large model, which on one hand enables the model to simultaneously understand both a global text and a local text in an image, and on the other hand improves the learning efficiency and the training efficiency of the model by having the model “spot-check” the local text in the image rather than requiring the model to “memorize” all text in the image.

When executing the step S104, the present embodiment can obtain the same number of target training samples and initial training samples based on a preset quantity, or obtain a quantity of initial training samples or a quantity of target training samples based on the quantity of the target training samples or the quantity of the initial training samples respectively.

When using an initial training sample to train the initial multimodal large model in the step S104, the present embodiment can input the initial sample image into the initial multimodal large model to obtain a predicted text output by the initial multimodal large model; obtain an initial loss function value based on the predicted text and a sample text; adjust parameters of the initial multimodal large model based on the target loss function value to obtain the target multimodal large model.

It should be understood that the present embodiment can simultaneously adjust the parameters of the initial multimodal large model based on both the target loss function value and the initial loss function value.

It should be understood that when the sample object is sample text, after completing the training of the initial multimodal large model in the step S104, the present embodiment can also obtain a public test set (such as a DocVQA test set) to test the obtained target multimodal large model.

The target multimodal large model obtained through training in S104 of the present embodiment is used to obtain a target answer corresponding to a target question based on a target image containing a target visual marker and the target question, meaning that this target multimodal large model has an ability to answer a user question based on an image containing a visual marker.

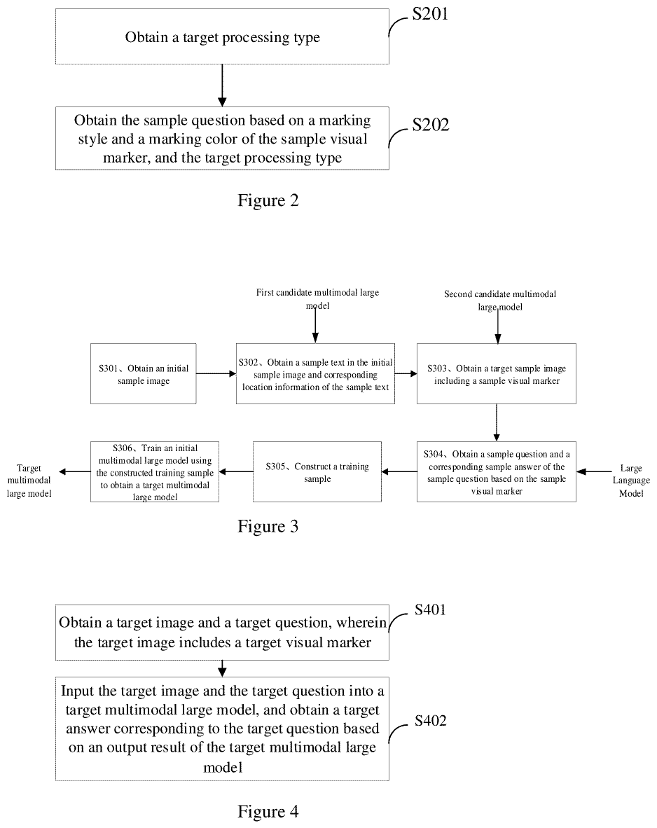

FIG. 2 is a schematic diagram according to a second embodiment of the present disclosure. As shown in FIG. 2, the present embodiment demonstrates that when executing the step S103 of “obtaining a sample question corresponding to the target sample image based on the sample visual marker”, it can include the following steps of:
S201: Obtaining a target processing type;
S202: Obtaining the sample question based on a marking style and a marking color of the sample visual marker, and the target processing type.

In other words, when the sample object is a sample text, the present embodiment uses not only the marking style and the marking color of the sample visual marker but also the obtained target processing type when obtaining the sample question, which makes the obtained sample question correspond to both the sample visual marker and the target processing type. This can enhance a diversity of different sample questions obtained, thereby strengthening the ability of the trained target multimodal large model to answer different types of questions.

In the present embodiment, a plurality of processing types for text processing can be preset, such as a text translation type, a text comprehension type, etc. ; Therefore, when executing the step S201, the present embodiment can randomly select one from a plurality of processing types as the target processing type.

For example, if the obtained target processing type is “text translation type” and the sample visual marker in the target sample image is “yellow highlighted”, then the sample question obtained in the step S202 can be “what is the translation of the yellow highlighted text in the image”; If the obtained target processing type is “text comprehension type” and the sample visual marker in the target sample image is “purple box”, then the sample question obtained in the step S202 can be “how to understand the text inside the purple box in the image”.

After obtaining the sample question in the step S202, the present embodiment can further execute the following steps to obtain the sample answer corresponding to the sample question: obtaining a sample text marked by the sample visual marker in the target sample image, the present embodiment will obtain at least one sample text (i.e., at least one target text when determining the target image region), which can be at least one Chinese character or at least one English word; obtaining the sample answer corresponding to the sample question based on the obtained at least one sample text and the target processing type.

It should be understood that when executing the step S202, the present embodiment can input the obtained sample text and the target processing type into a large language model, and then obtain the sample answer based on an output result of the large language model; For example, it can be obtaining a text translation result output by the large language model as the sample answer, or obtaining a text comprehension result output by the large language model as the sample answer, etc.

In other words, the present embodiment, under a premise of obtaining the sample question based on the target processing type, further obtains the sample answer corresponding to this sample question based on the target processing type and at least one sample text marked by the sample visual marker in the target sample image, which can improve the accuracy of the obtained sample answer.

FIG. 3 is a schematic diagram according to a third embodiment of the present disclosure. FIG. 3 shows a flow chart of the method for training multimodal large model in the present embodiment, which includes the steps of:
S301: Obtaining an initial sample image;
S302: Obtaining a sample text in the initial sample image and corresponding location information of the sample text;

The present embodiment can obtain the sample text and the corresponding location information of the sample text by inputting the initial sample image into a first candidate multimodal large model.
S303: Obtaining a target sample image including a sample visual marker;

The present embodiment can obtain the target sample image including the sample visual marker by inputting information such as the initial sample image, a target image region and a preset marking style into a second candidate large model.
S304: Obtaining a sample question and a corresponding sample answer of the sample question based on the sample visual marker;

The present embodiment can obtain the sample question and the corresponding sample answer of the sample question by inputting information such as a marking style, a marking color, a target question type of the sample visual marker into a large language model;
S305: Constructing a training sample;

The constructed training sample includes a target training sample (constituted by the target sample image, the sample question and the sample answer) and an initial training sample (constituted by the initial sample image and an included sample text of the initial sample image).
S306: Training an initial multimodal large model using the constructed training sample to obtain a target multimodal large model.

FIG. 4 is a schematic diagram according to a fourth embodiment of the present disclosure. As shown in FIG. 4, a method for image question answering of the present embodiment specifically includes the following steps of:
S401: Obtaining a target image and a target question, wherein the target image includes a target visual marker;
S402: Inputting the target image and the target question into a target multimodal large model, and obtaining a target answer corresponding to the target question based on an output result of the target multimodal large model.

In other words, the present embodiment uses a pre-trained target multimodal large model to generate a target answer corresponding to a target question based on an input target image containing a target visual marker and the target question, which can improve the question answering efficiency and the accuracy of the obtained target answer.

When executing the step S401, the present embodiment can provide an image editing interface to an input end after obtaining the target image uploaded by the input end, allowing the input end to add a target visual marker in the target image and simultaneously input the target question. After the input end clicks a send button in the image editing interface, the target image containing the target visual marker and the target question can be obtained.

The present embodiment does not restrict a marking style and/or a marking color of the target visual marker included in the target image; The target visual marker in the present embodiment is used to mark at least one text or at least one entity in the target image.

It should be understood that when executing the step S401, the present embodiment can also directly obtain the target image that already includes a target visual marker uploaded by the input end, where the input end does not need to perform image editing and only needs to input the target question.

In other words, the present embodiment inputs the target image containing a target visual marker into the target multimodal large model, enabling the target multimodal large model to generate a target answer corresponding to a target question based on at least one text or entity marked by the target visual marker, thereby achieving a purpose of allowing the input end to mark an object in the target image through various visual markers and ask a question, which can effectively improve the interaction efficiency between the input end and the multimodal large model, as well as the accuracy of the obtained target answer.

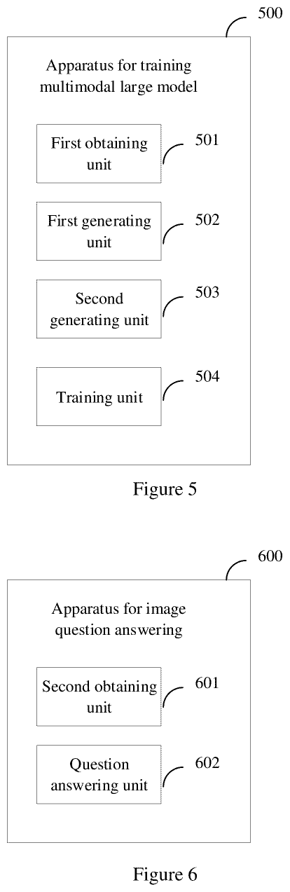

FIG. 5 is a schematic diagram according to a fifth embodiment of the present disclosure. As shown in FIG. 5, an apparatus 500 for training multimodal large model in the present embodiment includes:
a first obtaining unit 501, configured to obtain an initial sample image, a sample object in the initial sample image, and a location information of the sample object;
a first generating unit 502, configured to obtain a target sample image including a sample visual marker based on the initial sample image and a target image region corresponding to the initial sample image;
a second generating unit 503, configured to obtain a sample question corresponding to the target sample image based on the sample visual marker, and obtain a sample answer corresponding to the sample question;
a training unit 504, configured to train an initial multimodal large model based on a target training sample constituted by the target sample image, the sample question and the sample answer to obtain a target multimodal large model.

In the present embodiment, the sample object in the initial sample image can be a sample text included in the initial sample image, and the location information of the sample object is location information of the sample text in the initial sample image; Additionally, the sample object in the present embodiment can also be a sample entity such as an object or a person included in the initial sample image, and location information of the sample entity is location information of the aforementioned entity in the initial sample image.

The initial sample image obtained by the first obtaining unit 501 can be an image containing only a sample text (where a text in the sample image is the sample text), such as various types of document images including a table document, a text document, a chart document, etc. ; The initial sample image can also be an image that contains the sample text, meaning that besides the sample text, the initial sample image can also include another sample entity such as an object and a person.

After obtaining the initial sample image, the first obtaining unit 501 can perform Optical Character Recognition (OCR) on the initial sample image, and then obtain at least one sample text in the initial sample image and the location information of the at least one sample text in the initial sample image based on OCR recognition results.

After obtaining the initial sample image, the first obtaining unit 501 can also input the initial sample image into a first candidate multimodal large model, thereby obtaining at least one sample text in the initial sample image and the location information of the at least one sample text in the initial sample image based on an output result of the first candidate multimodal large model; The first candidate multimodal large model in the present embodiment can be an initial multimodal large model or another type of multimodal large model.

It should be understood that the first obtaining unit 501 can also input an obtained first prompt text together with the initial sample image into a candidate multimodal large model; The first prompt text in the present embodiment is used to instruct the first candidate multimodal large model to obtain a sample text and a corresponding location information of the sample text from the input initial sample image.

If the sample object in the present embodiment is a sample entity in the initial sample image, the first obtaining unit 501 can obtain the sample entity and the location information of the sample entity in the initial sample image through entity detection on the initial sample image.

After the first obtaining unit 501 obtains the initial sample image, the sample object in the initial sample image and the location information, the first generating unit 502 obtains a target sample image including a sample visual marker based on the initial sample image and a target image region corresponding to the initial sample image; In the present embodiment, the sample visual marker in the present embodiment is located in the target image region of the target sample image, which is used to mark a corresponding sample object (for example, at least one sample text) in the target sample image.

It should be understood that the target sample image obtained by the first generating unit 502, compared with the initial sample image, has only one difference: the target sample image includes a sample visual marker for marking a sample object located within the target image region, while image dimensions and image content are otherwise identical between the two.

If the sample object is a sample text, then the sample visual marker in the present embodiment is located in the target image region of the target sample image, which is used to mark the sample text within the target image region.

In the present embodiment, different target sample images can be obtained based on different initial sample images, and in different target sample images, sample visual markers can have different marking styles and/or different marking colors.

When obtaining a target sample image including a sample visual marker based on the initial sample image and the target image region corresponding to the initial sample image, the first generating unit 502 can implement as follows: determining the target image region corresponding to the initial sample image; inputting the target image region and the initial sample image into a second candidate multimodal large model; obtaining the target sample image including the sample visual marker based on an output result of the second candidate multimodal large model, where the sample visual marker is used to mark a sample object located within the target image region in the target sample image.

In the present embodiment, the second candidate multimodal large model can be the initial multimodal large model or another type of multimodal large model; The second candidate multimodal large model can be the same as or different from the first candidate multimodal large model.

In other words, the first generating unit 502 uses the second candidate multimodal large model to generate a sample visual marker in the target image region of the initial sample image, thereby obtaining a target sample image including the sample visual marker. Since the second candidate multimodal large model can generate a sample visual marker with a different marking style and/or a different marking color in the initial sample image, a diversity of sample visual markers included in different target sample images is enhanced, thereby strengthening an ability of the target multimodal large model to recognize different sample visual markers after training based on different target sample images.

When the sample object is sample text, the first generating unit 502 can determine the target image region corresponding to the initial sample image using the following method: selecting at least one target text from the sample text included in the initial sample image, where the present embodiment can use random selection to select at least one target text, but needs to ensure that a plurality of randomly selected target texts are consecutive; determining the target image region based on the location information of the selected at least one target text.

In other words, the first generating unit 502 determines the target image region corresponding to the initial sample image based on the location information of the target text selected from the initial sample image, achieving a purpose of automatically determining the target image region, thereby improving the efficiency of obtaining a target training sample.

Additionally, when the sample object is a sample text, the first generating unit 502 can also determine the target image region corresponding to the initial sample image based on text location information input from an input end; For example, if the input end inputs “the second line text”, then the present embodiment determines an image region corresponding to the “the second line text” in the initial sample image as the target image region.

The first generating unit 502 can also input an obtained second prompt text together with the target image region and the initial sample image into the second candidate multimodal large model; The second prompt text in the present embodiment is used to instruct the second candidate multimodal large model to generate a sample visual marker in the target image region of the initial sample image.

When inputting the initial sample image and the corresponding target image region into the second candidate multimodal large model, the first generating unit 502 can also include the following content: obtaining a preset marking style, when the sample object is a sample text, the preset marking style in the present embodiment can be a box marking, a highlight marking, an underline marking, a bold font marking, etc.; inputting the obtained preset marking style, the target image region and the initial sample image into the second candidate multimodal large model.

In other words, the first generating unit 502 enables the second candidate multimodal large model to generate a sample visual marker corresponding to a preset marking style in the initial sample image by inputting the preset marking style, thereby enhancing an ability of the target multimodal large model to recognize a visual marker of a specific style after training; It should be noted that the present embodiment does not restrict a marking color of the generated sample visual marker.

After the first generating unit 502 obtains the target sample image including a sample visual marker, the second generating unit 503 obtains a sample question corresponding to the target sample image based on the sample visual marker, and obtains a sample answer corresponding to the sample question.

The second generating unit 503 first obtains the sample question based on the sample visual marker, and then further obtains the corresponding sample answer based on the sample question.

When obtaining the sample question based on the sample visual marker, the second generating unit 503 can directly obtain the sample question based on a marking style and a marking color of the sample visual marker; In the present embodiment, the present embodiment can input the marking style and the marking color into a Large Language Model (LLM) and obtain the sample question based on an output result of the large language model.

After obtaining the sample question based on the marking style and the marking color of the sample visual marker, the second generating unit 503 can directly obtain at least one sample text (i.e., at least one target text) marked by the sample visual marker in the target sample image as the sample answer corresponding to the sample question.

When the sample object is sample text, when obtaining the sample question corresponding to the target sample image based on the sample visual marker, the second generating unit 503 can include the following content: obtaining a target processing type; obtaining the sample question based on a marking style and a marking color of the sample visual marker, and the target processing type.

In other words, when obtaining the sample question, the second generating unit 503 uses not only the marking style and the marking color of the sample visual marker but also an obtained target processing type, making the obtained sample question correspond to both the sample visual marker and the target processing type, which can enhance a diversity of different sample questions obtained, thereby strengthening an ability of the trained target multimodal large model to answer different types of questions.

In the present embodiment, a plurality of processing types for text processing can be preset, such as a text translation type, a text comprehension type, etc. ; Therefore, the second generating unit 503 can randomly select one from a plurality of processing types as a target processing type.

When the sample object is sample text, after obtaining the sample question, the second generating unit 503 can further execute the following content to obtain the sample answer corresponding to the sample question: obtaining a sample text marked by the sample visual marker in the target sample image, the present embodiment will obtain at least one sample text (i.e., at least one target text when determining the target image region), which can be at least one Chinese character or at least one English word; obtaining the sample answer corresponding to the sample question based on the obtained at least one sample text and the target processing type.

It should be understood that the second generating unit 503 can input the obtained sample text and the target processing type into a large language model, and then obtain the sample answer based on an output result of the large language model; For example, it can be obtaining a text translation result output by the large language model as the sample answer, or obtaining a text comprehension result output by the large language model as the sample answer, etc.

In other words, under a premise of obtaining the sample question based on the target processing type, the second generating unit 503 further obtains the sample answer corresponding to this sample question based on the target processing type and at least one sample text marked by the sample visual marker in the target sample image, which can improve the accuracy of the obtained sample answer.

After the second generating unit 503 obtains the sample question and the corresponding sample answer, the training unit 504 trains an initial multimodal large model based on a target training sample constituted by the target sample image, the sample question and the sample answer to obtain a target multimodal large model; In the present embodiment, the target multimodal large model obtained through training by the training unit 504 is used to obtain a target answer corresponding to a target question based on a target image containing a target visual marker and the target question.

In other words, the target multimodal large model trained by the training unit 504 using a target training sample can recognize a target visual marker included in the target image, and then combine an entity or a text corresponding to the target visual marker in the target image to answer a target question raised by a user, effectively improving the interaction efficiency between the user and the multimodal large model as well as the accuracy of the obtained target answer.

When training the initial multimodal large model based on the target training sample constituted by the target sample image, the sample question and the sample answer to obtain the target multimodal large model, the training unit 504 can implement as follows: inputting the target sample image and the sample question into the initial multimodal large model to obtain a predicted answer output by the initial multimodal large model; obtaining a target loss function value based on the predicted answer and the sample answer; adjusting parameters of the initial multimodal large model based on the target loss function value to obtain the target multimodal large model.

In other words, the training unit 504 determines the target loss function value by combining the predicted answer and the sample answer, and then adjusts the parameters of the initial multimodal large model based on the target loss function value, which can improve the training speed and the training accuracy of the model.

Additionally, when the sample object is a sample text, when training the initial multimodal large model based on the target training sample constituted by the target sample image, the sample question and the sample answer to obtain the target multimodal large model, the training unit 504 can also include the following content: obtaining an initial training sample based on the initial sample image and a sample text in the initial sample image; training the initial multimodal large model using the target training sample and the obtained initial training sample to obtain the target multimodal large model; wherein a quantity of the target training sample used in the present embodiment is equal to a quantity of the initial training sample.

In other words, the training unit 504 uses the target training sample and the initial training sample to train the initial multimodal large model, which on one hand enables the model to simultaneously understand both a global text and a local text in an image, and on the other hand improves the learning efficiency and the training efficiency of the model by having the model “spot-check” the local text in the image rather than requiring the model to “memorize” all text in the image.

The training unit 504 can obtain the same number of target training samples and initial training samples based on a preset quantity, or obtain a quantity of initial training samples or a quantity of target training samples based on the quantity of the target training samples or the quantity of the initial training samples respectively.

When using an initial training sample to train the initial multimodal large model, the training unit 504 can input the initial sample image into the initial multimodal large model to obtain a predicted text output by the initial multimodal large model; obtain an initial loss function value based on the predicted text and a sample text; adjusting parameters of the initial multimodal large model based on the target loss function value to obtain the target multimodal large model.

It should be understood that the training unit 504 can simultaneously adjust the parameters of the initial multimodal large model based on both the target loss function value and the initial loss function value.

It should be understood that when the sample object is sample text, after completing the training of the initial multimodal large model, the training unit 504 can also obtain a public test set (such as a DocVQA test set) to test the obtained target multimodal large model.

The target multimodal large model obtained through training by the training unit 504 is used to obtain a target answer corresponding to a target question based on a target image containing a target visual marker and the target question, meaning that this target multimodal large model has an ability to answer a user question based on an image containing a visual marker.

FIG. 6 is a schematic diagram according to a sixth embodiment of the present disclosure. As shown in FIG. 6, an apparatus 600 for image question answering in the present embodiment includes:
a second obtaining unit 601, configured to obtain a target image and a target question, wherein the target image includes a target visual marker;
a question answering unit 602, configured to input the target image and the target question into a target multimodal large model, and obtain a target answer corresponding to the target question based on an output result of the target multimodal large model.

In other words, the present embodiment uses a pre-trained target multimodal large model to generate a target answer corresponding to a target question based on an input target image containing a target visual marker and the target question, which can improve the question answering efficiency and the accuracy of the obtained target answer.

The second obtaining unit 601 can, after obtaining the target image uploaded by an input end, provide an image editing interface to the input end for adding a target visual marker to the target image and simultaneously inputting a target question. After the input end clicks a send button in the image editing interface, the target image containing the target visual marker and the target question can be obtained.

The present embodiment does not restrict a marking style and/or a marking color of the target visual marker included in the target image; The target visual marker in the present embodiment is used to mark at least one text or at least one entity in the target image.

It should be understood that the second obtaining unit 601 can also directly obtain the target image that already includes a target visual marker uploaded by the input end, where the input end does not need to perform image editing and only needs to input the target question.

In other words, the present embodiment inputs the target image containing a target visual marker into the target multimodal large model, which enables the target multimodal large model to generate a target answer corresponding to a target question based on at least one text marked by the target visual marker. Thereby, it can achieve a purpose of allowing the input end to mark a text in the target image through various visual markers and ask a question, which can effectively improve the interaction efficiency between the input end and the multimodal large model.

In the technical solutions of the present disclosure, the acquisition, storage, and application of user personal information comply with relevant laws and regulations and do not violate public order and good morals.

According to the embodiments of the present disclosure, the present disclosure also provides an electronic device, a readable storage medium, and a computer program product.

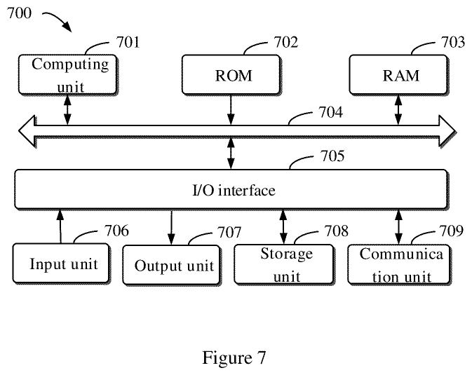

As shown in FIG. 7, it is a block diagram of an electronic device for implementing the method for training multimodal large model or the method for image question answering according to embodiments of the present disclosure. The electronic device is intended to represent various forms of digital computers, such as laptops, desktop computers, workstations, personal digital assistants, servers, blade servers, mainframes, and other suitable computers. The electronic device can also represent various forms of mobile devices, such as personal digital processors, cellular phones, smartphones, wearable devices, and other similar computing devices. The components shown herein, their connections and relationships, and their functions are meant merely as examples and are not intended to limit implementations of the disclosure described and/or claimed in this document.

As shown in FIG. 7, a device 700 includes a computing unit 701, which can execute various appropriate actions and processes according to a computer program stored in a Read-Only Memory (ROM) 702 or a computer program loaded from a storage unit 708 to a Random Access Memory (RAM) 703. Various programs and data required for the operation of the device 500 can also be stored in the RAM 703. The computing unit 701, the ROM 702, and the RAM 703 are interconnected via a bus 704. An Input/Output (I/O) interface 705 is also connected to the bus 704.

Multiple components in the device 700 are connected to the I/O interface 705, including: an input unit 706, such as a keyboard, a mouse, etc.; an output unit 707, such as various types of displays, speakers, etc.; a storage unit 708, such as a magnetic disk, an optical disk, etc.; and a communication unit 709, such as a network card, a modem, a wireless communication transceiver, etc. The communication unit 709 allows the device 700 to exchange information/data with other devices through a computer network such as the Internet and/or various telecommunications networks.

The computing unit 701 can be various general-purpose and/or specialized processing components with processing and computing capabilities. Some examples of the computing unit 701 include but are not limited to a Central Processing Unit (CPU), a Graphics Processing Unit (GPU), various specialized Artificial Intelligence (AI) computing chips, various computing units running machine learning model algorithms, a Digital Signal Processor (DSP), and any appropriate processor, controller, microcontroller, etc. The computing unit 701 executes the various methods and processes described above, such as the method for training multimodal large model or the method for image question answering. For example, in some embodiments, the method for training multimodal large model or the method for image question answering can be implemented as a computer software program that is tangibly included in a machine-readable medium, such as the storage unit 708.

In some embodiments, part or all of the computer program can be loaded and/or installed to the device 700 via the ROM 702 and/or the communication unit 709. When the computer program is loaded into the RAM 703 and executed by the computing unit 701, one or more steps of the method for training multimodal large model or the method for image question answering described above can be executed. Alternatively, in other embodiments, the computing unit 701 can be configured to execute the method for training multimodal large model or the method for image question answering through any other appropriate means (for example, through firmware).

Various implementations of the systems and techniques described herein can be realized in a digital electronic circuitry system, an integrated circuit system, a Field Programmable Gate Array (FPGA), an Application-Specific Integrated Circuit (ASIC), an Application-Specific Standard Product (ASSP), a System on Chip (SOC), a Complex Programmable Logic Device (CPLD), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

Program code for implementing methods of the present disclosure can be written in any combination of one or more programming languages. These program codes can be provided to a processor or a controller of a general-purpose computer, a special-purpose computer, or another programmable vehicle positioning or positioning model training device, such that when the program code is executed by the processor or the controller, functions/operations specified in the flowcharts and/or block diagrams are implemented. The program code can execute entirely on a machine, partly on the machine, partly on the machine as a standalone software package and partly on a remote machine, or entirely on the remote machine or a server.

In the context of the present disclosure, a machine-readable medium can be a tangible medium that can include or store a program for use by or in connection with an instruction execution system, apparatus, or device. The machine-readable medium can be a machine-readable signal medium or a machine-readable storage medium. The machine-readable medium can include but is not limited to an electronic, magnetic, optical, electromagnetic, infrared, or semiconductor system, apparatus, or device, or any suitable combination thereof. More specific examples of the machine-readable storage medium would include an electrical connection based on one or more wires, a portable computer diskette, a hard disk, a Random Access Memory (RAM), a Read-Only Memory (ROM), an Erasable Programmable Read-Only Memory (EPROM or flash memory), an optical fiber, a portable Compact Disc Read-Only Memory (CD-ROM), an optical storage device, a magnetic storage device, or any suitable combination thereof.

To provide interaction with a user, the systems and techniques described herein can be implemented on a computer having a display device (e.g., a CRT (Cathode Ray Tube) or LCD (Liquid Crystal Display) monitor) for displaying information to the user, and a keyboard and a pointing device (e.g., a mouse or a trackball) through which the user can provide input to the computer. Other kinds of devices can be used to provide interaction with a user; for example, feedback provided to the user can be any form of sensory feedback (e.g., visual feedback, auditory feedback, or tactile feedback); and input from the user can be received in any form, including acoustic, speech, or tactile input.

The systems and techniques described herein can be implemented in a computing system that includes a back-end component (e.g., as a data server), or a middleware component (e.g., an application server), or a front-end component (e.g., a user computer with a graphical user interface or a web browser through which a user can interact with implementations of the systems and techniques described here), or any combination of such back-end, middleware, or front-end components. The components of the system can be interconnected by any form or medium of digital data communication (e.g., a communication network). Examples of communication networks include: a Local Area Network (LAN), a Wide Area Network (WAN), and the Internet.

The computer system can include a client and a server. A client and a server are generally remote from each other and typically interact through a communication network. The relationship of client and server arises by virtue of computer programs running on respective computers and having a client-server relationship to each other. The server can be a cloud server, also known as a cloud computing server or a cloud host, which is a host product in a cloud computing service system, solving difficulties in management and weak business scalability that exist in a traditional physical host and a VPS service (“Virtual Private Server” or “VPS” for short). The server can also be a distributed system server or a blockchain-integrated server.

It should be understood that various forms of processes shown above can be used, with steps re-ordered, added, or removed. For example, the steps recorded in the present disclosure can be executed in parallel or sequentially or in different orders, as long as they can achieve the desired results of the technical solutions disclosed in the present disclosure, which are not limited herein.

The above specific embodiments do not constitute limitations on the scope of protection of the present disclosure. Those skilled in the art should understand that various modifications, combinations, sub-combinations and substitutions can be made according to design requirements and other factors. Any modifications, equivalent substitutions and improvements made within the spirit and principles of the present disclosure should be included within the scope of protection of the present disclosure.

What is claimed is:

1. A method for training multimodal large model, comprising:
obtaining an initial sample image, a sample object in the initial sample image, and a location information of the sample object;
obtaining a target sample image including a sample visual marker based on the initial sample image and a target image region corresponding to the initial sample image;
obtaining a sample question corresponding to the target sample image based on the sample visual marker, and obtaining a sample answer corresponding to the sample question;
training an initial multimodal large model based on a target training sample constituted by the target sample image, the sample question and the sample answer to obtain a target multimodal large model.

2. The method according to claim 1, wherein the sample object is a sample text in the initial sample image.

3. The method according to claim 2, wherein obtaining the sample text in the initial sample image and location information of the sample text comprises:
inputting the initial sample image into a first candidate multimodal large model;
obtaining the sample text and the location information of the sample text based on an output result of the first candidate multimodal large model.

4. The method according to claim 2, wherein obtaining the target sample image comprising the sample visual marker based on the initial sample image and the target image region corresponding to the initial sample image comprises:
determining the target image region corresponding to the initial sample image;
inputting the target image region and the initial sample image into a second candidate multimodal large model;
obtaining the target sample image comprising the sample visual marker based on an output result of the second candidate multimodal large model.

5. The method according to claim 4, wherein determining the target image region corresponding to the initial sample image comprises:
selecting at least one target text from the sample text included in the initial sample image;
determining the target image region based on location information of the at least one target text.

6. The method according to claim 4, wherein inputting the target image region and the initial sample image into the second candidate multimodal large model comprises:
obtaining a preset marking style;
inputting the preset marking style, the target image region and the initial sample image into the second candidate multimodal large model.

7. The method according to claim 2, wherein obtaining the sample question corresponding to the target sample image based on the sample visual marker comprises:
obtaining a target processing type;
obtaining the sample question based on a marking style and a marking color of the sample visual marker, and the target processing type.

8. The method according to claim 7, wherein obtaining the sample answer corresponding to the sample question comprises:
obtaining sample text marked by the sample visual marker in the target sample image;
obtaining the sample answer corresponding to the sample question based on the obtained sample text and the target processing type.

9. The method according to claim 1, wherein training the initial multimodal large model based on the target training sample constituted by the target sample image, the sample question and the sample answer to obtain the target multimodal large model comprises:
inputting the target sample image and the sample question into the initial multimodal large model to obtain a predicted answer output by the initial multimodal large model;
obtaining a target loss function value based on the predicted answer and the sample answer;
adjusting parameters of the initial multimodal large model based on the target loss function value to obtain the target multimodal large model.

10. The method according to claim 2, wherein training the initial multimodal large model based on the target training sample constituted by the target sample image, the sample question and the sample answer to obtain the target multimodal large model comprises:
obtaining an initial training sample based on the initial sample image and the sample text in the initial sample image;
training the initial multimodal large model using the target training sample and the initial training sample to obtain the target multimodal large model;
wherein a quantity of the target training sample is equal to a quantity of the initial training sample.

11. A method for image question answering, comprising:
obtaining a target image and a target question, wherein the target image includes a target visual marker;
inputting the target image and the target question into a target multimodal large model, and obtaining a target answer corresponding to the target question based on an output result of the target multimodal large model;
wherein the target multimodal large model is obtained through training by the methods according to claim 1.

12. An electronic device, comprising:
at least one processor; and
a memory communicatively connected with the at least one processor;
wherein the memory stores instructions executable by the at least one processor, and the instructions are executed by the at least one processor to enable the at least one processor to perform a method for training multimodal large model, wherein the method for training multimodal large model comprises:
obtaining an initial sample image, a sample object in the initial sample image, and a location information of the sample object;
obtaining a target sample image including a sample visual marker based on the initial sample image and a target image region corresponding to the initial sample image;
obtaining a sample question corresponding to the target sample image based on the sample visual marker, and obtaining a sample answer corresponding to the sample question;
training an initial multimodal large model based on a target training sample constituted by the target sample image, the sample question and the sample answer to obtain a target multimodal large model.

13. The electronic device according to claim 12, wherein the sample object is a sample text in the initial sample image.

14. The electronic device according to claim 13, wherein obtaining the sample text in the initial sample image and location information of the sample text comprises:
inputting the initial sample image into a first candidate multimodal large model;
obtaining the sample text and the location information of the sample text based on an output result of the first candidate multimodal large model.

15. The electronic device according to claim 13, wherein obtaining the target sample image comprising the sample visual marker based on the initial sample image and the target image region corresponding to the initial sample image comprises:
determining the target image region corresponding to the initial sample image;
inputting the target image region and the initial sample image into a second candidate multimodal large model;
obtaining the target sample image comprising the sample visual marker based on an output result of the second candidate multimodal large model.

16. The electronic device according to claim 15, wherein determining the target image region corresponding to the initial sample image comprises:
selecting at least one target text from the sample text included in the initial sample image;
determining the target image region based on location information of the at least one target text.

17. The electronic device according to claim 15, wherein inputting the target image region and the initial sample image into the second candidate multimodal large model comprises:
obtaining a preset marking style;
inputting the preset marking style, the target image region and the initial sample image into the second candidate multimodal large model.

18. The electronic device according to claim 13, wherein obtaining the sample question corresponding to the target sample image based on the sample visual marker comprises:
obtaining a target processing type;
obtaining the sample question based on a marking style and a marking color of the sample visual marker, and the target processing type.

19. The electronic device according to claim 18, wherein obtaining the sample answer corresponding to the sample question comprises:
obtaining sample text marked by the sample visual marker in the target sample image;
obtaining the sample answer corresponding to the sample question based on the obtained sample text and the target processing type.

20. A non-transitory computer readable storage medium with computer instructions stored thereon, wherein the computer instructions are used for causing a method for training multimodal large model, wherein the method for training multimodal large model comprises:
obtaining an initial sample image, a sample object in the initial sample image, and a location information of the sample object;
obtaining a target sample image including a sample visual marker based on the initial sample image and a target image region corresponding to the initial sample image;
obtaining a sample question corresponding to the target sample image based on the sample visual marker, and obtaining a sample answer corresponding to the sample question;
training an initial multimodal large model based on a target training sample constituted by the target sample image, the sample question and the sample answer to obtain a target multimodal large model.
